(19) United States
(12) Patent Application Publication
(10) Pub. No.: US 2020/0378446 A1
(43) Pub. Date: Dec. 3, 2020

(54) TRANSMISSION CONNECTION MECHANISM OF PANCAKE MOTOR

(71) Applicant: Shandong Lijiu Electrical Machinery Co., Ltd., Rushan City (CN)

(72) Inventors: Cheng ZHANG, Rushan City (CN); Xincheng DENG, Rushan City (CN); Fujie HE, Rushan City (CN); Wenyang LI, Rushan City (CN); Wenjie LV, Rushan City (CN); Jianwei LI, Shandong (CN)

(21) Appl. No.: 16/831,410

(22) Filed: Mar. 26, 2020

(30) Foreign Application Priority Data
May 31, 2019 (CN) 201920817220.1

(51) Int. Cl. F16D 1/10; F16C 35/063

(52) U.S. Cl. CPC F16D 1/10; F16D 2001/103; F16C 35/0635

(57) ABSTRACT

The invention relates to a transmission connection mechanism of a pancake motor, which solves the technical problem that the swing of an existing pancake motor affects the motor life. The transmission connection mechanism is provided with a motor shaft, a shaft sleeve and a working shaft, wherein the shaft sleeve and the working shaft are connected by a working key, the motor shaft is provided with an internal spline, an external spline is arranged outside the shaft sleeve, the internal spline and the external spline form a spline meshing connection, and the external spline is a spherical-tooth external spline. The transmission connection mechanism of the invention can be widely applied to the transmission connection of a pancake motor.

### FIELD OF THE INVENTION

The invention relates to the technical field of motor transmission, and particularly to a transmission connection mechanism of a pancake motor.

### BACKGROUND OF THE INVENTION

An existing pancake motor requires direct connection between a rotating shaft on its rotor and a working shaft of a device, but in general, due to space limitations, the pancake motor will swing during operation, and sometimes the deflection angle is greater than 2°, such that the working rotating shaft is not concentric with the rotating shaft of the motor, which will seriously affect the service life of the motor.

### SUMMARY OF THE INVENTION

In order to solve the technical problem that the swing of an existing pancake motor affects the motor life, the invention provides a transmission connection mechanism of a pancake motor, which allows a certain swing angle.

The invention provides a transmission connection mechanism of a pancake motor, which is provided with a motor shaft, a shaft sleeve and a working shaft, wherein the shaft sleeve and the working shaft are connected by a working key, the motor shaft is provided with an internal spline, an external spline is arranged outside the shaft sleeve, the internal spline and the external spline form a spline meshing connection, and the external spline is a spherical-tooth external spline.

Preferably, the external spline is a spherical-tooth involute spline.

Preferably, grease is distributed uniformly at the spline meshing connection.

Preferably, the grease is sealed by a sealing strip which forms a closed space with the outer periphery of the shaft sleeve and the inner periphery of the motor shaft to seal the grease.

Preferably, the shaft sleeve is provided with a shaft end baffle at an outer end thereof, and the shaft sleeve is fixed on the working shaft through the shaft end baffle and the working key.

Preferably, a mounting plate is arranged at a shaft extension of the motor shaft, and the mounting plate is fastened to the motor shaft by threaded connection.

The invention has the following beneficial effects:

in the invention, a spherical-tooth involute spline is used, a certain degree of deflection is allowed when the motor shaft is directly connected to the working shaft of a device, and the smooth operation of the motor is maintained when the deflection angle is not more than 3°, thus prolonging the service life of the motor while withstanding a larger workload;

in the invention, the grease is sealed by the sealing strip, which provides a simple structure and a good sealing effect; and

in the invention, the mounting plate is also provided so as to ensure the concentricity between the rotating shaft and the shaft sleeve, prevent the spline shaft sleeve and the motor shaft from deflection and protect the spherical-tooth external spline from being damaged by local stress during mounting, while providing a protective effect during transportation.

### BRIEF DESCRIPTION OF THE DRAWINGS

FIG. 1 is a front view showing a mounting state of the invention;

FIG. 2 is a left view showing a mounting state of the invention; and

FIG. 3 is a partially enlarged schematic view in a direction A of the invention.

Description of reference numerals:

10. pancake motor; 11. motor shaft; 12. internal spline; 20. external spline shaft sleeve; 21. sealing strip; 22. grease; 23. spherical-tooth external spline; 24. mounting plate; 25. socket cap screw; 30. working shaft; 31. working shaft key; 32. shaft end baffle; 33. external hexagon bolt; 34. stop spacer.

### DETAILED DESCRIPTION OF THE INVENTION

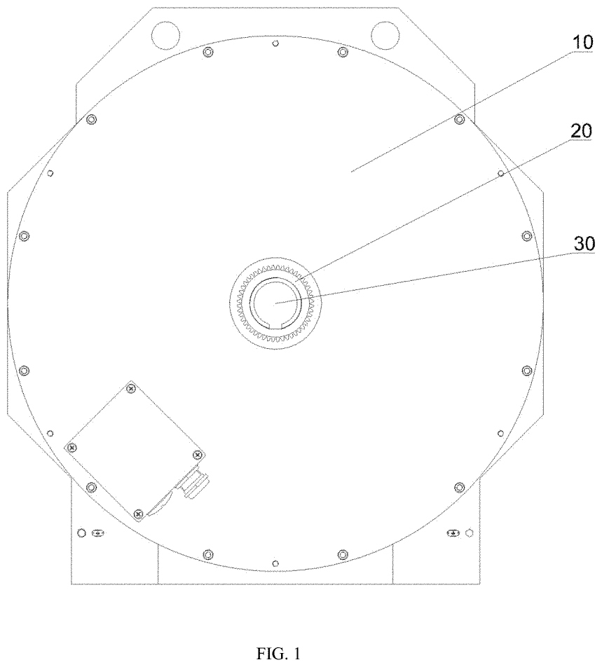

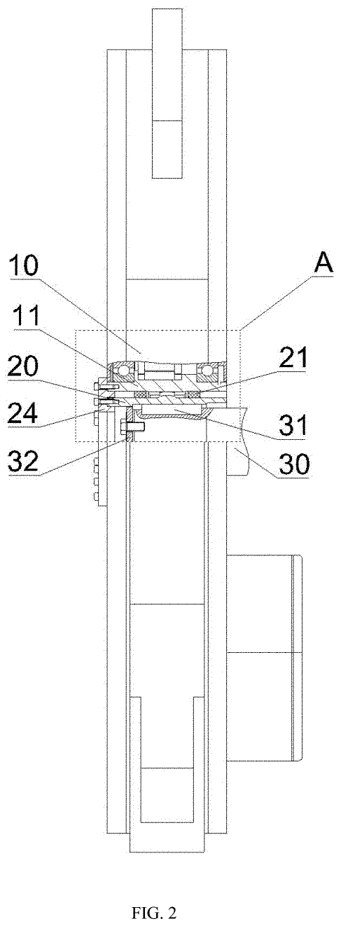

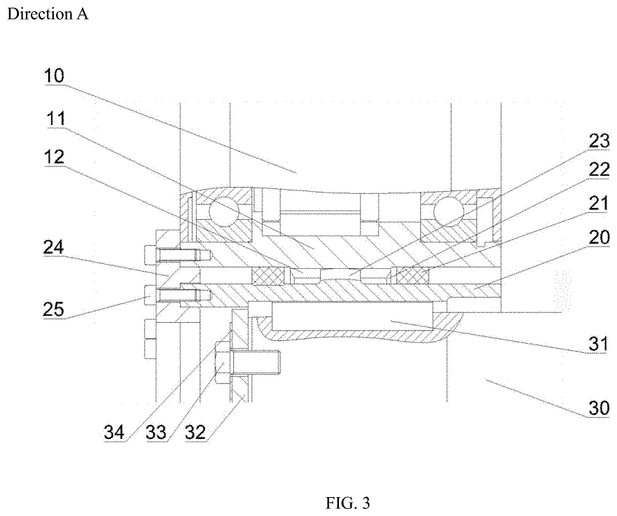

The invention will be further described below with reference to the drawings and embodiments, so that those skilled in the art of the invention can easily implement the invention. As shown in FIGS. 1 to 3, the invention is provided with an external spline shaft sleeve 20, a sealing strip 21, a mounting plate 24, and an internal spline 12 that cooperates with the external spline shaft sleeve 20, wherein an external spline 23 is arranged on an outer circumference of the external spline shaft sleeve 20 to cooperate with the internal spline 12, the internal spline 12 is located inside a motor shaft 11 of the pancake motor 10, the external spline 23 and the internal spline 12 form a spline meshing connection, the external spline 23 is a spherical-tooth involute spline, the spline meshing connection can allow the axis of the motor shaft 11 and the axis of the external spline shaft sleeve 20 to deflect in any direction by not more than 3°, grease 22 is injected at the spline meshing connection, and both ends of the grease are respectively sealed by the sealing strip 21 which forms a closed space with the outer periphery of the shaft sleeve and the inner periphery of the motor shaft to seal the grease, thereby ensuring that the grease 22 is not lost.

The mounting plate 24 is additionally mounted at a shaft extension of the external spline shaft sleeve 20. The mounting plate 24 is fixedly connected to the external spline shaft sleeve and the motor shaft 11 of the pancake motor 10 respectively through socket cap screws 25 so as to ensure the concentricity between the rotating shaft and the shaft sleeve, thus preventing the spline shaft sleeve and the motor shaft from deflection during mounting, and protecting the spherical-tooth external spline from being damaged by local stress. The external spline shaft sleeve 20 is internally provided with a keyway, which cooperates with a working shaft key 31 on a working shaft 30. The working shaft 30 is provided with a shaft end baffle 32 at an outer end thereof. The shaft end baffle 32 is fixed at an outer end of the working shaft 30 through an external hexagon bolt 33 and a stop spacer 34. The external spline shaft sleeve 20 is fixed on the working shaft 30 through the shaft end baffle 32 and the working shaft key 31.

In the invention, the motor shaft 11 of the pancake motor 10 is designed with the internal spline 12 to cooperate with the spherical-tooth external spline 23 of the external spline shaft sleeve 20, so that a certain deflection is allowed when the motor shaft 11 of the pancake motor 10 is directly connected to the working shaft 30 of a device, thus ensuring the smooth operation of the motor, prolonging the service life of the motor, and providing a simple and compact structure; the sealing strip 21 has a good sealing effect by effectively ensuring that the grease 22 is not lost; and the mounting plate 24 has a protective effect during transportation. The above description only refers to a preferred embodiment of the invention and is not intended to limit the invention. For those skilled in the art, various alterations and changes can be made to the invention. Any modification, equivalent replacement and improvement, etc. made within the scope defined by the claims of the invention shall fall within the protection scope of the invention.

1. A transmission connection mechanism of a pancake motor, which is provided with a motor shaft, a shaft sleeve and a working shaft, the shaft sleeve and the working shaft being connected by a working key, the motor shaft being provided with an internal spline, an external spline being arranged outside the shaft sleeve, and the internal spline and the external spline forming a spline meshing connection, wherein the external spline is a spherical-tooth external spline.

2. The transmission connection mechanism of a pancake motor according to claim 1, wherein the external spline is a spherical-tooth involute spline.

3. The transmission connection mechanism of a pancake motor according to claim 1, wherein grease is distributed uniformly at the spline meshing connection.

4. The transmission connection mechanism of a pancake motor according to claim 3, wherein the grease is sealed by a sealing strip which forms a closed space with the outer periphery of the shaft sleeve and the inner periphery of the motor shaft to seal the grease.

5. The transmission connection mechanism of a pancake motor according to claim 1, wherein the shaft sleeve is provided with a shaft end baffle at an outer end thereof, and the shaft sleeve is fixed on the working shaft through the shaft end baffle and the working key.

6. The transmission connection mechanism of a pancake motor according to claim 1, wherein a mounting plate is arranged at a shaft extension of the motor shaft, and the mounting plate is fastened to the motor shaft by threaded connection.
